(19) United States
(12) Patent Application Publication
(10) Pub. No.: US 2010/0275473 A1
(43) Pub. Date: Nov. 4, 2010

(54) Wear resistant components

(76) Inventor: Patrick Maher, Naval Base (AU)

Correspondence Address: ERNEST D. BUFF;ERNEST D. BUFF AND ASSOCIATES, LLC., 231 SOMERVILLE ROAD, BEDMINSTER, NJ, 07921, US

(21) Appl. No.: 12/803,716

(22) Filed: Jul. 2, 2010

(30) Foreign Application Priority Data
Jan. 4, 2008 (AU) 2008900028
Jan. 2, 2009 (AU) PCT/AU2009/000007

(51) Int. Cl. E02F 9/28; B32B 15/18; B32B 3/00; B32B 15/01

(52) U.S. Cl. 37/453; 428/686; 428/600; 428/681

(57) ABSTRACT

A wear component for ground engaging machinery is disclosed. The wear component has a shell formed from a first metallic material and an inner body formed from a second metallic material. The first material is relatively tough, and resistant to impact forces, and the second material is relatively abrasion resistant. A metallurgical bond exists between the first material and the second material.

### RELATED APPLICATION DATA

This application claims priority from AU Patent Application No. 2008900028, filed Jan. 4, 2008 and PCT/AU2009/000007, filed Jan. 2, 2009, both of which are incorporated herein in their entirety by reference hereto.

### BACKGROUND OF THE INVENTION

1. Field of the Invention

The present invention relates to components which are resistant to abrasive wear. The invention has been developed in relation to wear members of ground engaging machinery such as wear bars, buckets heel shrouds, ground engaging tools and the like. It is anticipated that the invention can also be used for other components subjected to abrasive wear.

2. Description of the Prior Art

Parts of earth moving machinery and related equipment are subject to significant wear during use, principally due to abrasion. In an attempt to reduce the effects of this abrasion, wear components are often mounted to earth moving buckets and similar machinery. Typical wear components include wear bars, bucket heel shrouds and ground engaging tools. The wear components are arranged to protect the parts of the machinery which would otherwise wear most rapidly. The wear components are designed to be relatively easy to replace, when worn.

It is desirable to make these wear components from abrasive resistant materials, in order to extend their working life and provide an enhanced benefit. It is also necessary to use materials which can withstand substantial impact forces, and the resulting stresses within the material. In general, it has been found that materials of high resistance to abrasive wear, such as chromium white irons and tungsten carbide composites, are generally too brittle to withstand the impact forces to which the wear components are frequently subjected.

Additional difficulties have been experienced in successfully attaching components made of these materials to earth moving equipment. The materials are generally incapable of being welded, and the provision of holes and the like in the component for mechanical attachment can lead to unacceptable stress concentrations and resultant failure when in use.

As a result, most wear members are made from quenched and tempered steel, as this provides excellent strength properties along with a degree of resistance to abrasion.

The present invention seeks to provide a component which is more resistant to abrasive wear than one made from steel, whilst still maintaining an acceptable resistance to impact forces in use, and being able to be readily attached.

### SUMMARY OF THE INVENTION

In accordance with a first aspect of the present invention there is provided a component formed from at least a first metallic material and a second metallic material, the first material having a toughness greater than that of the second material and the second material being more abrasion resistant than the first material; wherein the component has an shell formed from the first material and an inner body formed from the second material; and whereby a metallurgical bond exists between the first material and the second material. The first material acts to withstand impact forces, and the second material resists abrasion. The presence of a metallurgical bond reduces the propensity for stress concentrations and resultant cracking, and also reduces the propensity for shearing of one material relative to the other. ‘Toughness’, in this context, correlates to the absorbed impact energy required to fracture a specimen of material, and may be measured by a Charpy impact test.

Preferably the component has an outer wear face, the wear face having a perimeter formed by the first material and a central region formed by the second material. In this way the central region of the wear face is resistant to abrasive wear. The perimeter of the wear face may be thicker than other parts of the shell. This may allow a stronger bond to form at the wear face during manufacture than would otherwise be the case.

It is desirable that the first material be one which can be readily welded onto, for instance, a mild steel base. In a preferred embodiment of the present invention, the first material is mild steel. This allows ready connection of the component onto the machinery to be protected. Other suitably tough materials such as carbon steels may be used in other embodiments of the invention. It is considered desirable that the first material have a Charpy impact energy of above 40 J, measured in a V-notch test at 20° C. By way of contrast, the second material may have a Charpy impact energy below 10 J.

Preferably, the shell includes a base opposed to the outer wear face, the base being shaped for ready attachment to ground engaging machinery.

The second material is preferably a material with hardness greater than 300 HB (more preferably greater than 400 HB). In a preferred embodiment of the present invention, the second material is an alloyed white iron. This provides significant resistance to abrasive wear. By way of contrast, the first material may have a hardness in the order of 100-200 HB.

In accordance with a second aspect of the present invention there is provided a wear bar for ground engaging machinery, the wear bar being formed from at least a first metallic material and a second metallic material, the first material having a toughness greater than that of the second material and the second material being more abrasion resistant than the first material; wherein the component has an shell formed from the first material and an inner body formed from the second material; and whereby a metallurgical bond exists between the first material and the second material. In a preferred embodiment the wear bar is elongate, having a transverse cross-sectional profile which is substantially constant along at least a portion of the bar. The shell includes a base which is arranged for attachment to the machinery, and side walls which extend from the base. Preferably, the side walls are inwardly tapered with respect to each other towards the outer wear face. This inward tapering assists in distributing stresses due to side impacts so as to reduce the propensity for shearing to occur around the area of the metallurgical bond. It also assists in providing a mechanical retention of the second material within the shell in the event of an incomplete metallurgical bond being formed.

The side walls each have an upper edge defining the perimeter of the outer wear face. Preferably, the side walls are thicker at their upper edge than adjacent the shell base. This compensates for erosion which might occur around the upper edge as a result of the formation of the component.

The shell base preferably includes an elongate recess which may be located, in use, about a curved portion of the bucket.

In accordance with a third aspect of the present invention there is provided a heel shroud for an excavator bucket, the heel shroud being formed from at least a first metallic material and a second metallic material, the first material having a toughness greater than that of the second material and the second material being more abrasion resistant than the first material; wherein the component has a shell formed from the first material and an inner body formed from the second material; and whereby a metallurgical bond exists between the first material and the second material. In a preferred embodiment, the shell has a base formed from a first wall shaped to locate about an excavator bucket heel, and a second wall extending from an edge of the first wall to create a ‘V’ shape which opens towards the wear face. Side walls extend about the base to define a substantially rectangular wear face perimeter. The inner body thus has two portions, a substantially rectangular prismatic portion extending inwardly of the wear face, and a substantially triangular prismatic portion located, in use, adjacent a side wall of the bucket.

In accordance with a fourth aspect of the present invention there is provided a tooth for ground engaging machinery, the tooth being formed from at least a first metallic material and a second metallic material, the first material having a toughness greater than that of the second material and the second material being more abrasion resistant than the first material; wherein the component has an shell formed from the first material and an inner body formed from the second material; and whereby a metallurgical bond exists between the first material and the second material.

Other embodiments of the invention will be apparent to a skilled addressee.

### BRIEF DESCRIPTION OF THE DRAWINGS

It will be convenient to further describe the invention with reference to preferred embodiments of the present invention. Other embodiments are possible, and consequently, the particularity of the following discussion is not to be understood as superseding the generality of the preceding description of the invention. In the drawings:

FIG. 1a is a transverse cross sectional view of a wear bar in accordance with the present invention;

FIG. 1 b is plan view of the wear bar of FIG. 1;

FIG. 2a is a perspective of a heel shroud in accordance with the present invention;

FIG. 2b is a cross sectional view of the heel shroud of FIG. 2a; and

FIG. 3 is a partially cut-away view of a ground engaging tool in accordance with the present invention.

### DESCRIPTION OF THE PREFERRED EMBODIMENT

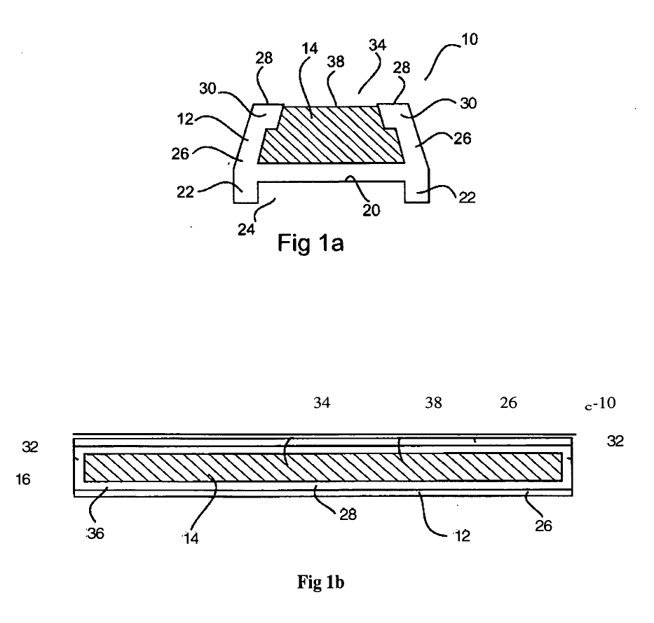

FIGS. 1(a) and 1(b) show a wear bar 10 constructed in accordance with 5 the present invention. The wear bar 10 comprises a shell 12 and an inner body 14.

The wear bar 10 is elongate, extending from a first end 16 to a second end 18. The wear bar 10 has a substantially uniform transverse cross section, which is shown in FIG. 1(a).

The shell 12 has a base 20, which is substantially rectangular and extends along the length of the wear bar 10. The base 20 has two side portions 22 depending from it, so as to create a rectangular elongate recess 24 located on an underside of the wear bar 10.

The shell 12 has two side walls 26, extending away from the base 20 on the opposite side to the elongate recess 24. The side walls 26 each have an upper edge 28. The side walls 26 are inwardly tapered, such that the respective upper edges 28 are closer to each other than the side walls 26 at the base 20.

The side walls 26 are not of uniform thickness. Instead, each side wall has an enlarged region 30 at its upper edge 28. The arrangement is such that the enlarged region 30 is thicker than the remainder of the side wall 26, with the enlarged part protruding inwardly of the shell 12, towards the other side wall 26.

The shell 12 also includes end walls 32, extending perpendicularly of the base 20 at the first and second ends 16, 18 of the wear bar 10. The end walls 32 are of the same height as the side walls 26.

The base 20, side walls 26 and end walls 32 co-operate to define a cavity which is substantially prismatic in configuration. During manufacture, this cavity is filled with material to form the inner body 14.

The inner body 14 is thus surrounded by the shell 12 except for the region between the upper edges 28 of the shell side walls 26.

This region forms part of a wear face 34 of the wear bar 10. The wear face 34 is located on the opposite face of the wear bar 10 to the recess 24, and can best be seen in FIG. 1(b). The wear face 34 has a rectangular outer periphery 36 formed by the upper edges 28 of the shell side walls 26 and corresponding upper edges of the shell end walls 32. The wear face 34 has a rectangular central region 38, being the exposed surface of the inner body 14.

During manufacture, the shell 12 is formed by casting or machining a first metallic material. The first metallic material should have a relatively high fracture toughness, and require relatively high impact energy to cause fracture. It should also be able to be easily welded to an excavator bucket or other ground engaging machinery. Suitable materials include mild steels and higher strength carbon steels, and some steel alloys. The materials may require suitable treatment, such as quenching and tempering, in order to achieve the desired properties.

The inner body is then formed using a second metallic material. The second metallic material should have a high degree of resistance to abrasion. Suitable materials include alloy white irons. One alloy developed for this application, and considered particularly useful, is a white iron including 9-15% chromium; 3.5-4.5% carbon; 0.4-0.7% silicon; 1.0-4.0% manganese; and 0.5-3.0% nickel.

It is a key feature of the invention that a metallurgical bond is created directly between the first metallic material and the second metallic material. The applicant proposes to achieve this by use of the process disclosed in International PCT Publication WO 02/01996, the contents of which are incorporated herein by reference. It will therefore be appreciated that although the drawings show a clear boundary between the shell 12 and the inner body 14, in fact there will be a transition region between the two materials, the transition region being a metal matrix including both materials.

When suitably formed, the wear bar 10 can be attached to an excavator bucket or other ground engaging machinery. The wear bar 10 is arranged so that it can be fitted about a curve of the bucket, with a curved part of the bucket being located within the recess 24. The wear bar 10 can be attached by welding of the side portions 22 of the base 20 directly to the bucket. In this way the outer wear face 34 will be facing away from the bucket, and will be exposed to the abrasive forces of the material through which the bucket is being passed. At the same time, the inner body 14 is protected from side impact forces due to the geometry of the wear bar 10.

It is envisaged that a wear bar created in accordance with this description will have a significantly longer usable life than wear bars created from quenched and tempered steel. As a corollary, it will be possible to manufacture a significantly smaller and lighter wear bar having the same usable life than one made entirely from quenched and tempered steel.

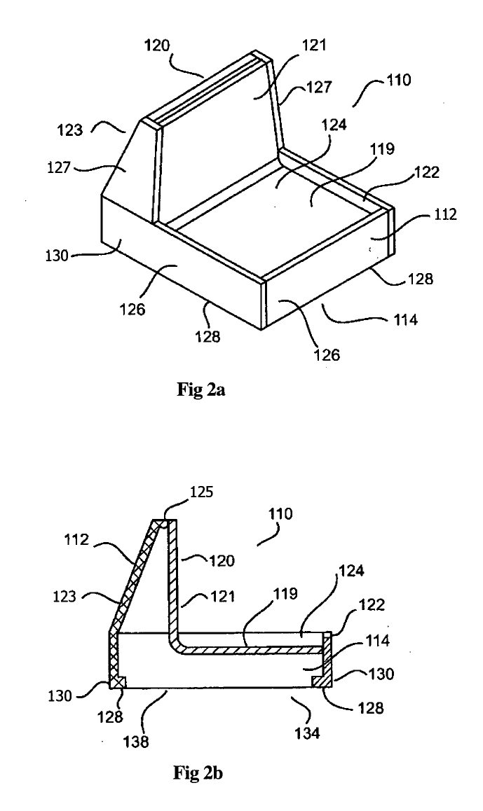

FIGS. 2(a) and 2(b) show a heel shroud 110 constructed in accordance with the present invention. The heel shroud 110 comprises a shell 112 and an inner body 114.

The shell 112 has a base 120, formed by a substantially L shaped first wall and a second wall 123. The first wall has a first portion 119 which locates, in use, substantially parallel to a base of an excavator bucket, and a second portion 121 which locates, in use, substantially parallel to a side wall of an excavator bucket. The first wall is thus substantially complementary in shape to the heel of an excavator bucket, with the first and second portions 119, 121 being substantially perpendicular to each other.

The second portion 121 has an outer edge 125 extending along the width of the shell 114, along the edge remote from the first portion 119.

The second wall 123 extends from the outer edge 125 at an acute angle to the second portion 121 of the first wall. In the embodiment of the drawings, the angle is about 25°. As a result, this portion of the base 120 is substantially V-shaped in cross section. This can be seen in FIG. 2(b).

The shell 112 has two first side walls 127 which extend between the second wall 123 and the second portion 121 of the first wall. The first side walls 127 thus represent ends of a triangular prism.

The shell 112 has four second side walls 126. These extend about the first portion 119 of the first wall in a direction away from the second portion 121, and also act as a extension of the second wall 123 and the first side walls 127. The second side walls 126 define a substantially rectangular prism.

The second side walls 126 about the first portion 119 of the first wall 30 extend on both sides of the first portion 119. In other words, side wall portions 122 extend from three edges of the first portion 119 on the same side as the second portion 121. These side wall portions 122 cooperate with the second portion 121 to form a rectangular recess 124 located on the side of the heel shroud 110 arranged to lie against a bucket heel.

The side walls 126 are not of uniform thickness. Instead, each side wall has an enlarged region 130 at its outer edge 128. The arrangement is such that the enlarged region 130 is thicker than the remainder of the side wall 126, with the enlarged part protruding inwardly of the shell 112, towards an opposed side wall 126.

The base 120, first side walls 127 and second side walls 126 co-operate to define a cavity which is substantially prismatic in configuration. During manufacture, this cavity is filled with material to form the inner body 114. The inner body thus has two portions, a substantially rectangular prismatic portion within the second side walls 126, and a substantially triangular prismatic portion located between the first side walls 127.

The inner body 114 is thus surrounded by the shell 112 except for the region between the outer edges 128 of the shell second side walls 126.

This region forms part of a wear face 134 of the heel shroud 110. The wear face 134 is located on the opposite face of the heel shroud 10 to the recess 124, and can best be seen in FIG. 2(b). The wear face 134 has a rectangular outer periphery formed by the outer edges 128 of the second side walls 126. The wear face 134 has a rectangular central region 138, being the exposed surface of the inner body 114.

During manufacture, the shell 112 is formed by casting or machining a first metallic material. The first metallic material should have a relatively high fracture toughness, and require relatively high impact energy to cause fracture. It should also be able to be easily welded to an excavator bucket or other ground engaging machinery. Suitable materials include mild steels and higher strength carbon steels, and some steel alloys. The materials may require suitable treatment, such as quenching and tempering, in order to achieve the desired properties.

The inner body 114 is then formed using a second metallic material. The second metallic material should have a high degree of resistance to abrasion. Suitable materials include alloy white irons. One alloy developed for this application, and considered particularly useful, is a white iron including 9-15% chromium; 3.5-4.5% carbon; 0.4-0.7% silicon; 1.0-4.0% manganese; and 0.5-3.0% nickel.

It is a key feature of the invention that a metallurgical bond is created directly between the first metallic material and the second metallic material. The applicant proposes to achieve this by use of the process disclosed in International PCT Publication WO 02101996, the contents of which are incorporated herein by reference. It will therefore be appreciated that although the drawings show a clear boundary between the shell 112 and the inner body 114, in fact there will be a transition region between the two materials, the transition region being a metal matrix including both materials.

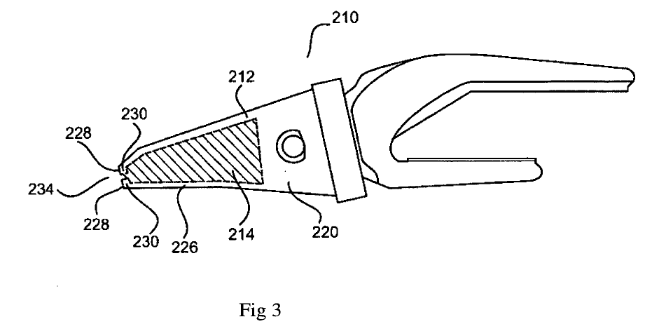

FIG. 3 shows a tooth 210 for ground engaging machinery, the tooth being constructed in accordance with the present invention. The tooth 210 comprises a shell 212 and an inner body 214.

In the embodiment shown, the shell 212 is comprised of a base 220, being the worn stub of an existing tooth, and side walls 226 which have been attached to the base 220 to form the required tooth shape.

The side walls 226 are not of uniform thickness. Instead, each side wall has an enlarged region 230 at its outer edge 228. The arrangement is such that the enlarged region 230 is thicker than the remainder of the side wall 226 (which may be in the order of 10 mm thick), with the enlarged part protruding inwardly of the shell 212, towards an opposed side wall 226.

The base 220, and side walls 226 co-operate to define a cavity. During manufacture, this cavity is filled with material to form the inner body 214. The inner body 214 is thus surrounded by the shell 212 except for the region between the outer edges 228 of the shell second side walls 226.

This region forms part of a wear face 234 of the tooth 210. The wear face 234 is located on the tip of the tooth 210. The wear face 234 has a rectangular outer periphery formed by the outer edges 228 of the second side walls 226. The wear face 234 has a rectangular central region, being the exposed surface of the inner body 214.

During manufacture, the shell 212 is formed by casting or machining a first metallic material. This may be a refurbishment of an existing tooth, or may be creating of a new tooth. The first metallic material should have a relatively high fracture toughness, and require relatively high impact energy to cause fracture. It should also be able to be easily welded to an excavator bucket or other ground engaging machinery. Suitable materials include mild steels and higher strength carbon steels, and some steel alloys. The materials may require suitable treatment, such as quenching and tempering, in order to achieve the desired properties.

The inner body 214 is then formed using a second metallic material. The second metallic material should have a high degree of resistance to abrasion. Suitable materials include alloy white irons. One alloy developed for this application, and considered particularly useful, is a white iron including 9-15% chromium; 3.5-4.5% carbon; 0.4-0.7% silicon; 1.0-4.0% manganese; and 0.5-3.0% nickel.

It is a key feature of the invention that a metallurgical bond is created directly between the first metallic material and the second metallic material. The applicant proposes to achieve this by use of the process disclosed in International PCT Publication WO 02/01996, the contents of which are incorporated herein by reference. It will therefore be appreciated that although the drawings show a clear boundary between the shell 212 and the inner body 214, in fact there will be a transition region between the two materials, the transition region being a metal matrix including both materials.

1. A component formed from at least a first metallic material and a second metallic material, the first material having a toughness greater than that of the second material and the second material being more abrasion resistant than the first material; wherein the component has an shell formed from the first material and an inner body formed from the second material; and whereby a metallurgical bond exists between the first material and the second material.

2. A component as claimed in claim 1, wherein the component has an outer wear face, the wear face having a perimeter formed by the first material and a central region formed by the second material.

3. A component as claimed in claim 2, wherein the shell has a thicker portion at the wear face perimeter.

4. A component as claimed in claim 1, wherein the first metallic material is one which can be readily welded.

5. A component as claimed in claim 1, wherein the first metallic material has a Charpy impact energy of above 4 OJ, measured in a V-notch test at 200 C.

6. A component as claimed in claim 1, wherein the second metallic material has a hardness greater than 300 HB.

7. A component as claimed in claim 6, wherein the second metallic material is an alloyed white iron.

8. A component as claimed in claim 7, wherein the second metallic material includes 9-15% chromium.

9. A component as claimed in claim 7, wherein the second metallic material includes 3.5-4.5% carbon;

10. A component as claimed in claim 7, wherein the second metallic material includes 0.4-0.7% silicon.

11. A component as claimed in claim 7, wherein the second metallic material includes 1.0-4.0% manganese.

12. A component as claimed in claim 7, wherein the second metallic material includes 0.5-3.0% nickel.

13. A component as claimed in claim 1, wherein the shell includes a base opposed to the outer wear face, the base being shaped for ready attachment to ground engaging machinery

14. A wear bar for ground engaging machinery, formed from at least a first metallic material and a second metallic material, the first material having a toughness greater than that of the second material and the second material being more abrasion resistant than the first material; wherein the wear bar has a shell formed from the first material and an inner body formed from the second material; and whereby a metallurgical bond exists between the first material and the second material.

15. A wear bar as claimed in claim 14, wherein the wear bar is elongate, having a transverse cross-sectional profile which is substantially constant along at least a portion of the bar.

16. A wear bar as claimed in claim 14, wherein the shell includes a base which is arranged for attachment to the machinery, and side walls which extend from the base.

17. A wear bar as claimed in claim 16, wherein the side walls are inwardly tapered with respect to each other towards an outer wear face.

18. A wear bar as claimed in claim 16, wherein the side walls are thicker at their upper edge than adjacent the shell base.

19. A wear bar as claimed in claim 14, wherein the shell includes an elongate recess which can locate, in use about a curved portion of the ground engaging machinery.

20. A heel shroud for an excavator bucket, formed from at least a first metallic material and a second metallic material, the first material having a toughness greater than that of the second material and the second material being more abrasion resistant than the first material; wherein the heel shroud has a shell formed from the first material and an inner body formed from the second material; and whereby a metallurgical bond exists between the first material and the second material.

21. A heel shroud as claimed in claim 20, wherein the shell has a base formed from an L-shaped first wall and a second wall extending from an edge of the first wall to create a ‘V shape which opens towards the wear face.

22. A heel shroud as claimed in claim 21, wherein substantially triangular first side walls extend between the first wall and the second wall, defining a substantially triangular prismatic portion of the inner body.

23. A heel shroud as claimed in claim 20, wherein side walls extend about the base to define a substantially rectangular wear face perimeter.

24. A heel shroud as claimed in claim 20, wherein the base includes a recess arranged to locate against an excavator bucket.

25. A tooth for ground engaging machinery, formed from at least a first metallic material and a second metallic material, the first material having a toughness greater than that of the second material and the second material being more abrasion resistant than the first material; wherein the tooth has a shell formed form the first material and an inner body formed from the second material; and whereby a metallurgical bond exists between the first material and the second material;

26. A wear bar as claimed in claim 14, wherein the wear bar has an outer wear face, the wear face having a perimeter formed by the first material and a central region formed by the second material;

27. A wear bar as claimed in claim 26, wherein the shell has a thicker portion at the wear face perimeter;

28. A wear bar as claimed in claim 14, wherein the first metallic material is one which can be readily wielded;

29. A wear bar as claimed in claim 14, wherein the first metallic material has a Charpy impact energy of above 40 J, measured in a V-notch test at 200 C;

30. A wear bar as claimed in claim 14, wherein the second metallic material has hardness greater than 300 HB;

31. A wear bar as claimed in claim 30, wherein the second metallic material is an alloyed white iron;

32. A wear bar as claimed in claim 31, wherein the second metallic material includes 9-15% chromium;

33. A wear bar as claimed in claim 31, wherein the second metallic material includes 3.5-4.5% carbon;

34. A wear bar as claimed in claim 31, wherein the second metallic material includes 0.4-0.7% silicon;

35. A wear bar as claimed in claim 31, wherein the second metallic material includes 1.0-4.0% manganese;

36. A wear bar as claimed in claim 31, wherein the second metallic material includes 0.5-3.0% nickel;

37. A wear bar as claimed in claim 14, wherein the shell includes a base opposed to the outer wear face, the base being shaped for ready attachment to ground engaging machinery;

38. A heel shroud as claimed in claim 20, wherein the heel shroud has an outer wear face, the wear face having a perimeter formed by the first material and a central region formed by the second material; 2

39. A heel shroud as claimed in claim 38, wherein the shell has a thicker portion at the wear face perimeter;

40. A heel shroud as claimed in claim 20, wherein the first metallic material is one which can be readily wielded;

41. A heel shroud as claimed in claim 20, wherein the first metallic material has a Charpy impact energy of above 40 J, measured in a V-notch test at 200 C;

42. A heel shroud as claimed in claim 20, wherein the second metallic material has a hardness greater than 300 HB;

43. A heel shroud as claimed in claim 42, wherein the second metallic material is an alloyed white iron;

44. A heel shroud as claimed in claim 43, wherein the second metallic material includes 9-15% chromium;

45. A heel shroud as claimed in claim 43, wherein the second metallic material includes 3.5-4.5% carbon;

46. A heel shroud as claimed in claim 43, wherein the second metallic material includes 0.4-0.7% silicon;

47. A heel shroud as claimed in claim 43, wherein the second metallic material includes 1.0-4.0% manganese;

48. A heel shroud as claimed in claim 43, wherein the second metallic material includes 0.5-3.0% nickel;

49. A heel shroud as claimed in claim 20, wherein the shell includes a base opposed to the outer wear face, the base being shaped for ready attachment to ground engaging machinery.
